(19) United States
(12) Patent Application Publication
(10) Pub. No.: US 2019/0293520 A1
(43) Pub. Date: Sep. 26, 2019

(54) METHOD DEVICE AND SYSTEM FOR ESTIMATING LIFE OF A TECHNICAL SYSTEM

(71) Applicants: Vinay Ramanath, Bangalore (IN); Asmi Rizvi Khaleeli, Bangalore (IN); AJAY KUMAR THARWANI, Bhilwara (IN); Garrett Waycaster, Pineville, NC (US)

(72) Inventors: Vinay Ramanath, Bangalore (IN); Asmi Rizvi Khaleeli, Bangalore (IN); AJAY KUMAR THARWANI, Bhilwara (IN); Garrett Waycaster, Pineville, NC (US)

(21) Appl. No.: 15/926,252

(22) Filed: Mar. 20, 2018

(51) Int. Cl. G01M 99/00

(52) U.S. Cl. CPC G01M 99/007; G01M 99/005

(57) ABSTRACT

A method, device and system of estimation life of a technical system comprising of at least one material, is disclosed. The method includes generating a coefficient distribution by determining probability distribution of condition coefficients associated with the material. The condition coefficients include stress-strain coefficient, stress-life coefficient and structure coefficients. Further, the method includes sampling the coefficient distribution at a high confidence region and a low confidence region. The life of the material is estimated based on the sampled high confidence region and the sampled low confidence region.

### FIELD

The present invention relates generally to life estimation of a technical system.

### BACKGROUND

Generally, materials used in technical systems are chosen to improve the performance of the technical system's efficiency. To improve the technical system's efficiency, life prediction of material used in components of the technical system is determined.

The material lifing models are used to characterize both the inherent behaviour variations in material as well as our confidence in a given model when faced with limited test data. Traditionally, safety factors derived from prior experience are used to understand variations in the material. With the usage of new materials, accurate representation of variability of the materials is preferred.

### SUMMARY

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

In accordance with one aspect of the invention, there is provided a method of estimation life of a technical system. The technical system is made up of one or more materials. The method includes generating a coefficient distribution by determining probability distribution of condition coefficients associated with the material. The condition coefficients include stress-strain coefficient, stress-life coefficient and structure coefficients. Further, the method includes sampling the coefficient distribution at a high confidence region and a low confidence region. Furthermore, the method includes estimating life of the material based on the sampled high confidence region and the sampled low confidence region.

In an embodiment, the method includes weighing the samples based on a confidence function on each of the condition coefficients. The high confidence region indicates on higher confidence function of the condition coefficients as with respect to the low likelihood region with lower confidence function. Further, the sampling is performed by sampling the coefficient distribution at the high confidence region at a faster rate in relation to the low confidence region.

In accordance with another aspect of the invention, there is provided a life estimation device for a technical system. The technical system made up of one or more materials. The device including a receiver to receive test data and one or more processors. The device also includes a memory communicatively coupled to the at least one processor. The memory further comprises a distribution module to generate a coefficient distribution from the test data by determining probability distribution of condition coefficients associated with the material. For example, the condition coefficients include stress-strain coefficient, stress-life coefficient and structure coefficients. The memory includes a sampling module to sample the coefficient distribution at a high confidence region and a low confidence region. The method also includes a life estimation module to estimate life of the material based on the sampled high confidence region and the sampled low confidence region.

In accordance with yet another aspect of the invention there is provided a life estimation system for a technical plant. The technical plant includes multiple technical systems made up of one or more materials. The system a server operable on a cloud computing platform and a network interface communicatively coupled to the server. The system also includes life estimation device for each of the technical systems to estimate life of the one or more material of the technical system.

### BRIEF DESCRIPTION OF THE FIGURES

The present invention is further described hereinafter with reference to illustrated embodiments shown in the accompanying drawings, in which:

FIG. 1 illustrates stages of estimation life of materials of a technical system, according to the present invention;

FIG. 2 illustrates stages of determining coefficient distribution according to the present invention;

FIG. 3 illustrates sampling of a coefficient distribution based on confidence regions, according to an aspect of the present invention;

FIG. 4 is a flowchart illustrating a method of estimation life of a technical system made up of one or more materials, according to the present invention;

FIG. 5 is a block diagram of a life estimation device according to the present invention; and

FIG. 6 is a block diagram of a life estimation system for a technical plant according to the present invention.

### DETAILED DESCRIPTION

Various embodiments are described with reference to the drawings, wherein like reference numerals are used to refer to like elements throughout. In the following description, turbine has been considered as an example of a technical system for the purpose of explanation. Further, numerous specific details are set forth in order to provide thorough understanding of one or more embodiments of the present invention. These examples must not be considered to limit the application of the invention to turbines and includes any technical system such as motors, medical instruments or any structure whose material life is to be estimated. It may be evident that such embodiments may be practiced without these specific details limiting the application to turbines.

As used herein, the term “test data” refers to the data recorded in relation to operation of a material in a technical system, such as rotor in a turbine for a spectrum of operating conditions. The data recorded reflects the condition of the technical system, such as strain, stress, temperature, etc. The condition of the technical system is provided as “condition coefficients” and can also be referred to parameters or attributes of the technical system. For example, the condition coefficients include stress-strain coefficient, stress-life coefficient and structure coefficients of the rotor in the turbine.

Further, the test data is used to determine load capability of the material prior to failure. The test data can be recorded for multiple materials capable of being used in the making of the technical systems. In the present invention “test data” can also be referred to as “observed data”.

The term “fatigue” refers to a failure mode caused by cyclic loading of the technical system. The fatigue can be empirically determined based on stress-life analysis and the strain-life analysis. Fatigue life of the technical system or a component of the technical system is determined by crack initiation, crack propagation and final failure. The fatigue life is affected by uncertainties caused by material properties, model errors, parameter estimates, load variation and structural component properties in engineering. The present invention specifically addresses the model errors to improve estimation of life of the technical system

As used herein “probability distribution” refers to probabilistic model of variation in load on the technical system and variation in input parameters to the technical system. The probabilistic model is modelled as distributions to provide probable distributions of performance of the technical system.

Hereinafter, “prior” refers to known knowledge or assumption of parameters associated with the technical system. For example, priors are coefficients used in determining the condition of the technical system, such as the stress-strain coefficient, the stress-life coefficient and the structure coefficients. Further, the priors are distributed based on variations in load and input parameters. Accordingly “prior distribution” is generated. As used herein “prior distribution” also refers to “coefficient distribution”. For example, the probability distribution of stress-life coefficient for a combustor in a turbine is a coefficient distribution.

The term “likelihood” refers to a measure of support provided by the test data or observed data for each coefficient distribution values associated with the technical system. A function of the likelihood is referred to as “likelihood function” or “confidence function”.

As used herein “posterior” refers to a combination of known knowledge or assumptions and confidence on the observed data with respect to the known knowledge. The probability distribution of the “posterior” is referred to as “posterior distribution”.

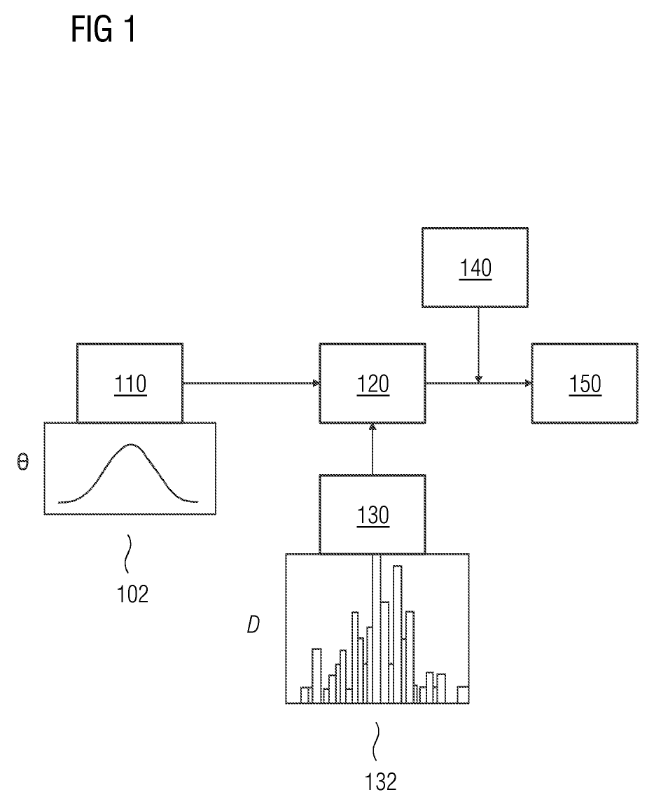

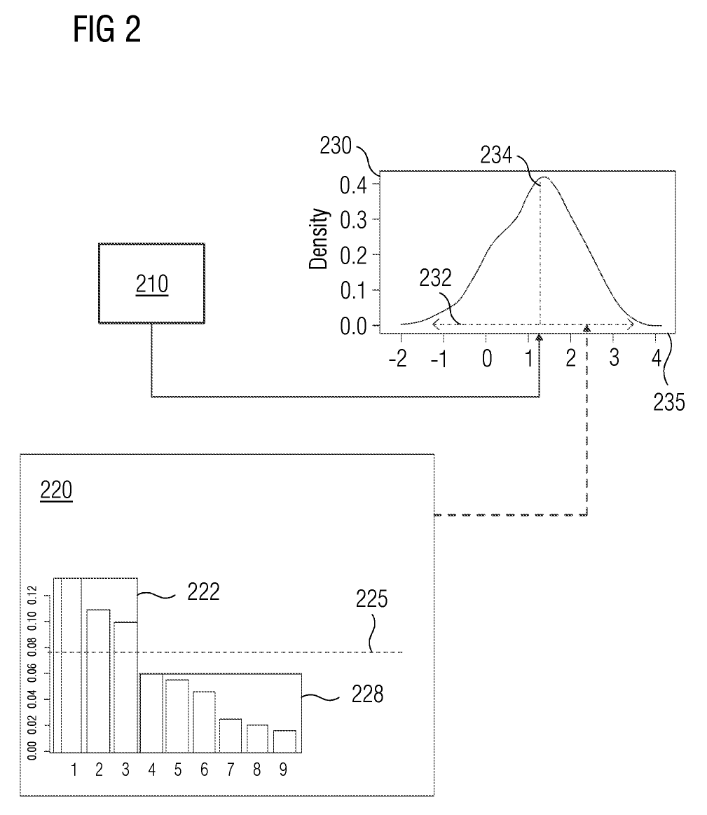

FIG. 1 illustrates stages of estimation life of materials of a technical system, according to the present invention. As shown in FIG. 1, the prior/condition coefficients associated with the technical system is denoted by θ. At stage 110, probabilistic distribution of the condition coefficients is determined. Accordingly, the coefficient distribution 102 is a graph indicating the probabilistic distribution of the condition coefficients. The steps performed to accurately determine the coefficient distribution is further elaborated in FIG. 2.

At stage 120, the confidence function L is determined. To determine the confidence function, test data D is obtained at stage 130. As shown in the figure the test data is indicated by graph 132.

Based on the confidence function L determined at stage 120, nested sampling is performed at stage 140. The term “nested sampling” refers a sampling method to relate the confidence function with the coefficient distribution. The sampling method results in nested contours of the confidence function with regard to the coefficient distribution.

At stage 150, posterior distribution P is determined. The posterior distribution is a distribution of estimated life of the technical system. Accordingly, the posterior distribution is determined by the below equation.

$$P ( θ \vert D ) = \frac{π ( θ ) L ( θ )}{\int π ( θ ) L ( θ ) d θ}$$

where π is the prior distribution, L is the likelihood or the confidence function, d indicates the dimensions for the numerical integration.

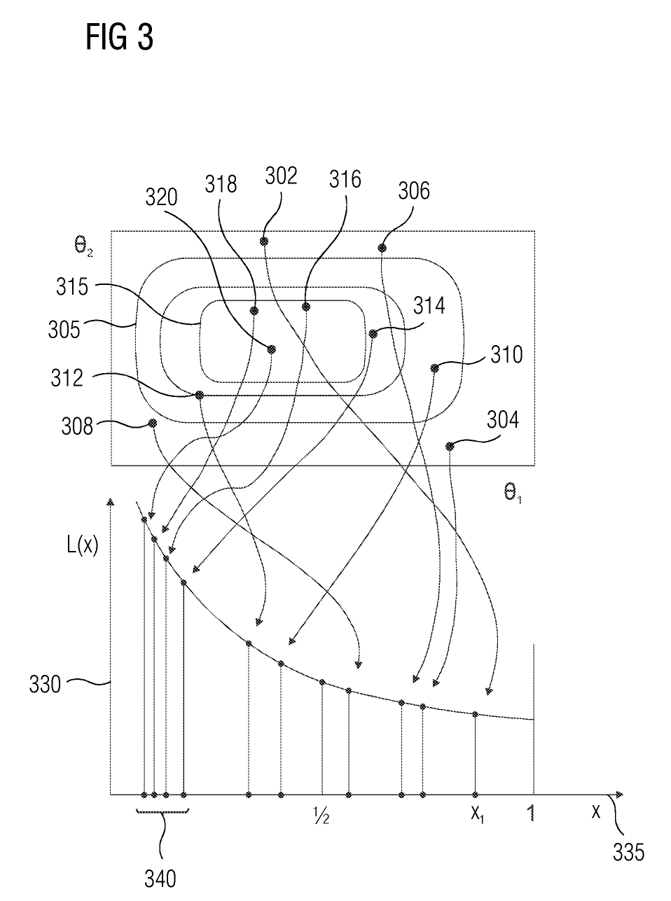

The advantage of the nested sampling is that the posterior distribution is arrived at a faster rate with improved accuracy. The nested sampling enables transformation of coefficient distribution from multi-dimensional integral into a one-dimensional integral. The steps performed in the nested sampling stage 140 and the posterior distribution stage 150, are further elaborated in FIG. 3.

FIG. 2 illustrates stages of determining coefficient distribution according to the present invention. As indicated herein above, coefficient distribution and prior distribution are used interchangeably. As shown in FIG. 2, at stage 210 optimized condition coefficients are determined. The optimized condition coefficient θₒₚₜ is indicated in the graph at 234. Further, at stage 210, deterministic optimization is used to determine mean of the condition coefficient. Accordingly, “optimized condition coefficient θₒₚₜ” is also referred to as prior mean.

Deterministic optimization approach is advantageous in view of high number of inter-dependent condition coefficients. The present method of optimization avoids assuming coefficient distribution though trial and error approach, which is prone to errors. In an embodiment, particle swarm optimization method is used to determine the optimized condition coefficients.

At stage 220, sensitivity analysis is performed on the condition coefficients to determine width of the coefficient distribution. As used herein, the width of the coefficient distribution is also referred to as “distribution limits”. The distribution limits are generated by determining the variance around the optimized condition coefficient θₒₚₜ.

The sensitivity analysis is depicted by bar graph with condition coefficients on x-axis and density on y-axis. The more sensitive condition coefficients 222 are determined with respect to a sensitivity cut-off 225. The sensitivity cut-off is programmable or pre-determined based on the physics of the technical system. The less sensitive condition coefficients 228 are indicated below the sensitivity cut-off 225.

In an embodiment, a surrogate model is constructed on test data from the technical system. On the surrogate model a sensitivity analysis is applied. In another embodiment, data of the surrogate model can be obtained from prediction models. As used herein, “sensitivity” refers to influence of perturbations in inputs parameters.

As shown in FIG. 2, the condition coefficients 235 are plotted against density 230 on the y-axis. The optimized condition coefficient 234 is indicated as the mean of the prior. Further, the distribution limits 232 derived from the sensitivity analysis stage 220 indicate the limits of the coefficient distribution.

In an embodiment, in case of higher sensitivity the range is determined by

α=θₒₚₜ−0.01*θₒₚₜ and b=θₒₚₜ+0.01*θₒₚₜ
In case of lower sensitivity, the range is determined by
α=θₒₚₜ−0.5*θₒₚₜ and b=θₒₚₜ+0.5*θₒₚₜ

The variance around the prior mean is derived by

$$\frac{{( b - a )}^{2}}{12} .$$

Accordingly, to sum up the determination of mean in the coefficient distribution is the result of the outcome after performing a deterministic optimization. While the Sensitivity analysis is employed as a reasoning scheme for arriving at variance to the mean.

FIG. 3 illustrates sampling of the coefficient distribution based on confidence regions. As used herein, “confidence region” is derived by determining the likelihood or confidence from the test data with respect to the condition coefficients. As shown in FIG. 3, the condition coefficients 302-320 are plotted in 2 dimensional space as a contour map of condition coefficients θ₁ and θ₂. The concentric contours in the contour map indicate same confidence in the confidence region. For example, outermost contour 305 indicates same confidence value in lesser confidence region. While innermost contour 350 indicates same confidence value in higher confidence region.

FIG. 3 also includes a plot of the confidence L(x) 330 versus vector x 335 of the condition coefficients θ₁ and θ₂. As shown in the plot at 340, the high confidence region inside and around the contour 350 is sample more frequently as compared to the lower confidence regions. The method of sampling high confidence region at a faster rate than lower confidence regions is referred to as “Nested Sampling”.

In an embodiment, the nested sampling is performed to calculate posterior weights that are used to derive estimated life of the technical system. The equation pₜ=Lᵢ*wᵢ id used to calculate posterior weights. Where pᵢ is posterior weight, Lᵢ is the likelihood/confidence value of the i^{th} iteration and wᵢ quantifies the condition coefficients.

Using nested sampling estimated life of the technical system is generated from the condition coefficients that have highest support in the test data. Accordingly, the nested sampling method addresses the drawbacks associated with the popular Markov Chain Monte Carlo (MCMC) sampling method, which requires tuning parameters from a user.

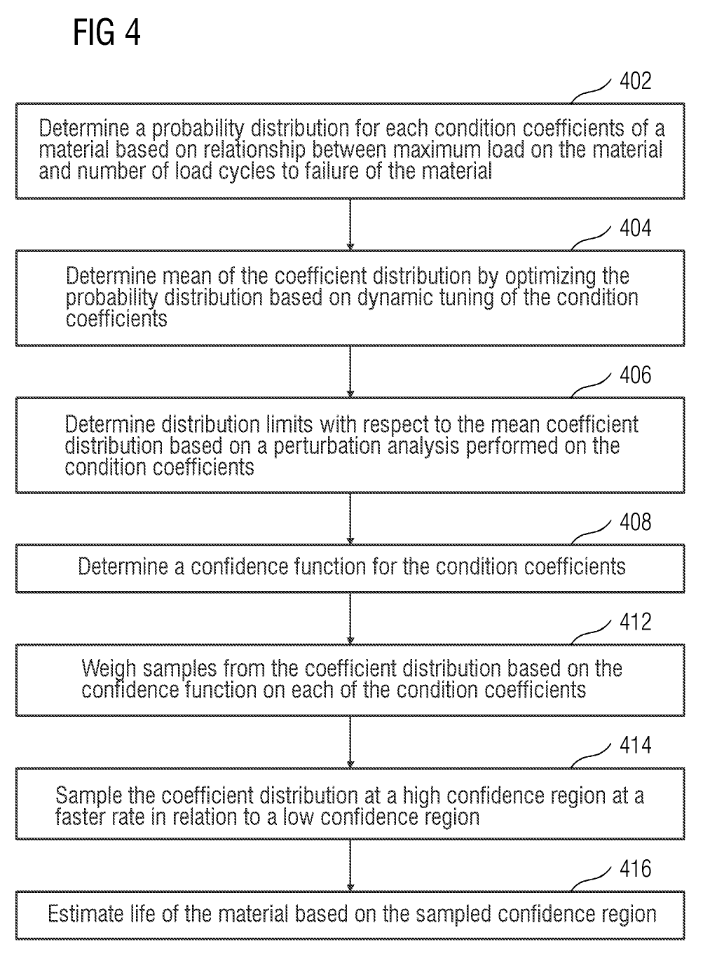

FIG. 4 is a flowchart illustrating a method of estimation life of a technical system made up of one or more materials. The method begins at step 402 with the determination of a probability distribution for each condition coefficients of the material. The probability distribution is determined based on relationship between maximum load on the material and number of load cycles to failure of the material. For example, condition coefficients include fatigue strength exponent, fatigue ductility coefficient, etc. The probability distribution of the condition coefficients is referred hereinafter as coefficient distribution.

At step 404 mean of the coefficient distribution is determined by optimizing the probability distribution based on dynamic tuning of the condition coefficients. The dynamic tuning is performed by optimization methods such as particle swarm optimization. Thereafter at step 406, distribution limits with respect to the mean coefficient distribution based on a perturbation analysis performed on the condition coefficients. The generation of the coefficient distribution from the optimized probability distribution and the perturbation analysis has been explained in FIG. 2.

At step 408, a confidence function for the condition coefficients is determined as a measure of the support provided in the test data. At step 412, the confidence function is used to weigh samples from the coefficient distribution. In other words, samples from the coefficient distribution weighed based on the confidence function on each of the condition coefficients. At step 414, the samples from high confidence region is obtained at a faster rate in relation to a low confidence region. The confidence regions are obtained from the confidence function and the sampling process is explained in FIG. 3.

At step 416, life of the materials of the technical system is estimated based on the sampled coefficient distribution. The method is advantageous as the sampling probes the entire coefficient distribution and in succession samples from the more likely regions of the condition coefficient space. The samples taken outside the likely regions with negligible posterior weights are neglected automatically and hence post processing is not required.

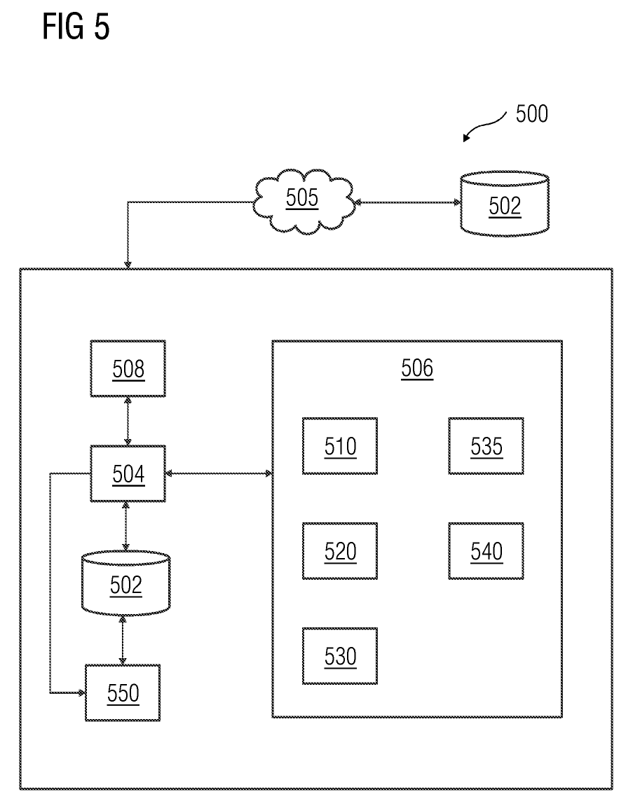

FIG. 5 is a block diagram of a life estimation device 500. The life estimation device according to the present invention is installed on and accessible by a user device, for example, a personal computing device, a workstation, a client device, a network enabled computing device, any other suitable computing equipment, and combinations of multiple pieces of computing equipment. The life estimation device disclosed herein is in operable communication with a database 502 over a communication network 505.

The database 502 is, for example, a structured query language (SQL) data store or a not only SQL (NoSQL) data store. In an embodiment of the database 502 according to the present invention, the database 502 can also be a location on a file system directly accessible by the life estimation device 500. In another embodiment of the database 502 according to the present invention, the database 502 is configured as cloud based database implemented in a cloud computing environment, where computing resources are delivered as a service over the network 505.

As used herein, “cloud computing environment” refers to a processing environment comprising configurable computing physical and logical resources, for example, networks, servers, storage, applications, services, etc., and data distributed over the network 505, for example, the internet. The cloud computing environment provides on-demand network access to a shared pool of the configurable computing physical and logical resources. The communication network 505 is, for example, a wired network, a wireless network, a communication network, or a network formed from any combination of these networks.

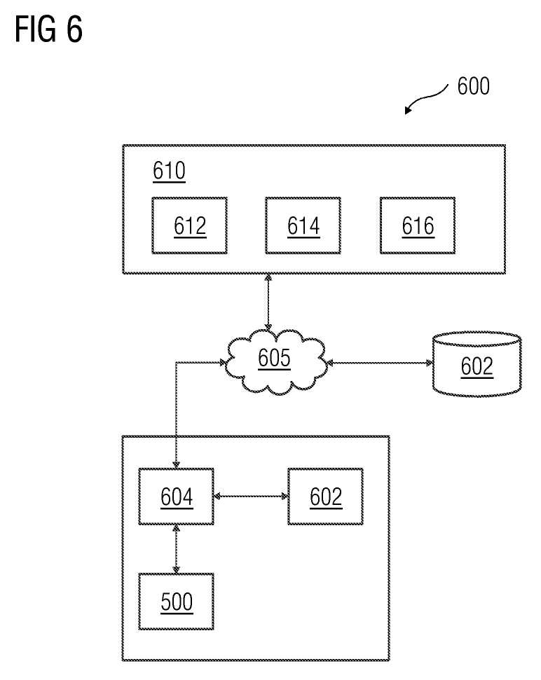

In a preferred embodiment according to the present invention, the life estimation device 500 is downloadable and usable on the user device. In another embodiment according to the present invention, the life estimation device is configured as a web based platform, for example, a website hosted on a server or a network of servers. In another embodiment according to the present invention, the life estimation device is implemented in the cloud computing environment. The life estimation device is developed, for example, using Google App engine cloud infrastructure of Google Inc., Amazon Web Services® of Amazon Technologies, Inc., as disclosed hereinafter in FIG. 6. In an embodiment, the life estimation device is configured as a cloud computing based platform implemented as a service for analyzing data.

The life estimation device disclosed herein comprises memory 506 and at least one processor 504 communicatively coupled to the memory 506. As used herein, “memory” refers to all computer readable media, for example, non-volatile media, volatile media, and transmission media except for a transitory, propagating signal. The memory is configured to store computer program instructions defined by modules, for example, 510, 520, 530, etc., of the life estimation device. The processor 504 is configured to execute the defined computer program instructions in the modules. Further, the processor 504 is configured to execute the instructions in the memory 506 simultaneously.

As illustrated in FIG. 5, the life estimation device comprises a communication unit 508 including a receiver to receive the test data from the technical system and a display unit 550. Additionally, a user using the user device can access the life estimation device via a GUI (graphic user interface). The GUI is, for example, an online web interface, a web based downloadable application interface, etc.

The modules executed by the processor 504 include distribution module 510, sampling module 520, validation module 530, confidence function module 535 and life estimation module 540.

The distribution module 510 generates a coefficient distribution from test data by determining probability distribution of condition coefficients associated with the material. For example, the condition coefficients include stress-strain coefficient, stress-life coefficient and structure coefficients. Estimation of the distribution of the condition coefficients is significant to the estimation of life of the technical system. This is because, correct assumption of the condition coefficients leads to accurate life estimate.

The distribution module 510 accurately predicts mean of the condition coefficient distribution by optimizing probability distribution of the condition coefficients. The optimization is performed based on dynamic tuning of the condition coefficients.

Further, the distribution module 510 determined variance with respect to the mean by a perturbation analysis. The perturbation analysis includes classification of sensitivity. In an embodiment, the classification of sensitivity is determined based on expected life of the technical system. To classify sensitivity, a cut-off criterion is chosen based on the assumption that highly sensitive parameters contribute more to the response variation and less sensitive parameters contribute lesser to the response variation. In an embodiment, the cut-off criterion is determined based on 80-20 rule. Accordingly, highly sensitive parameters contribute 80% to the response variation and less sensitive parameters contribute 20% to the response variation.

After the coefficient distribution is determined by the distribution module 510, the sampling module 520 is used to sample the coefficient distribution at based on a confidence function. The confidence function is determined using the validation module 530 and the confidence function module 535.

The validation module 530 validates each of the condition coefficients with known condition of the material. The known condition comprises material domain knowledge, test data associated with the material, physics model and mathematical model of the technical system. The confidence module 535 then determines the confidence function based on the validation of each of the condition coefficients.

As a result of the confidence function, the coefficient distribution can be mapped into high confidence regions and low confidence regions. The high confidence region indicates on higher confidence function of the condition coefficients as with respect to the low likelihood region with lower confidence function.

The sampling module 520 samples the coefficient distribution at the high confidence region at a faster rate in relation to the low confidence region. The method of sampling is referred to as nested sampling and the same has been elaborated under FIG. 3, herein above.

The life estimation module 540 then estimates life of the material based on the sampled high confidence region and the sampled low confidence region. The life estimation module estimates life by determining a posterior distribution P. The posterior distribution is a distribution of estimated life of the technical system. Accordingly, the posterior distribution is determined by the below equation.

$$P ( θ \vert D ) = \frac{π ( θ ) L ( θ )}{\int π ( θ ) L ( θ ) d θ}$$

where π is the prior distribution, L is the likelihood or the confidence function, d indicates the dimensions for the numerical integration.

FIG. 6 is a block diagram of of a life estimation system 600 for a technical plant 610. The system 600 includes a server 604 comprising the life estimation device 500. The system 600 also comprises a network interface 605 communicatively coupled to the server 604 and technical plant 610 comprising technical systems 612-616. The server 604 includes the life estimation device 500 for estimating life of at least one material in the technical systems 612-616 of the technical plant.

In an embodiment, the technical plant 610 maybe located in a remote location while the server 604 is located on a cloud server for example, using Google App engine cloud infrastructure of Google Inc., Amazon Web Services® of Amazon Technologies, Inc., the Amazon elastic compute cloud EC2® web service of Amazon Technologies, Inc., the Google® Cloud platform of Google Inc., the Microsoft® Cloud platform of Microsoft Corporation, etc. In case the server 604 is a cloud server, the life estimation device 500 also is implemented in the cloud computing environment.

The life estimation system 600 also includes a database 602. The database can be a cloud database connected to the network interface 605. In another embodiment, the database is connected to the server 604. The database 602 includes information relating to operation of the technical plant including details of the conditions such as, material domain knowledge, test data associated with the material, physics model and mathematical model of the technical systems 612-616.

The above disclosed method, device and system may be achieved via implementations with differing or entirely different components, beyond the specific components and/or circuitry set forth above. With regard to such other components (e.g., circuitry, computing/processing components, etc.) and/or computer-readable media associated with or embodying the present invention, for example, aspects of the invention herein may be implemented consistent with numerous general purpose or special purpose computing systems or configurations. Various exemplary computing systems, environments, and/or configurations that may be suitable for use with the disclosed subject matter may include, but are not limited to, various clock-related circuitry, such as that within personal computers, servers or server computing devices such as routing/connectivity components, hand-held or laptop devices, multiprocessor systems, microprocessor-based systems, set top boxes, smart phones, consumer electronic devices, network PCs, other existing computer platforms, distributed computing environments that include one or more of the above systems or devices, etc.

In some instances, aspects of the invention herein may be achieved via logic and/or logic instructions including program modules, executed in association with the circuitry, for example. In general, program modules may include routines, programs, objects, components, data structures, etc. that perform particular tasks or implement particular control, delay or instructions. The inventions may also be practiced in the context of distributed circuit settings where circuitry is connected via communication buses, circuitry or links. In distributed settings, control/instructions may occur from both local and remote computer storage media including memory storage devices.

The system and computing device along with their components herein may also include and/or utilize one or more type of computer readable media. Computer readable media can be any available media that is resident on, associable with, or can be accessed by such circuits and/or computing components. By way of example, and not limitation, computer readable media may comprise computer storage media and communication media. Computer storage media includes volatile and non-volatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and can accessed by computing component. Communication media may comprise computer readable instructions, data structures, program modules or other data embodying the functionality herein. Further, communication media may include wired media such as a wired network or direct-wired connection, and wireless media such as acoustic, RF, infrared, 4G and 5G cellular networks and other wireless media. Combinations of the any of the above are also included within the scope of computer readable media.

In the present description, the terms component, module, device, etc. may refer to any type of logical or functional circuits, blocks and/or processes that may be implemented in a variety of ways. For example, the functions of various circuits and/or blocks can be combined with one another into any other number of modules. Each module may even be implemented as a software program stored on a tangible memory (e.g., random access memory, read only memory, CD-ROM memory, hard disk drive) to be read by a central processing unit to implement the functions of the invention herein. Or, the modules can comprise programming instructions transmitted to a general purpose computer or to processing/graphics hardware via a transmission carrier wave. Also, the modules can be implemented as hardware logic circuitry implementing the functions encompassed by the invention herein. Finally, the modules can be implemented using special purpose instructions (SIMD instructions), field programmable logic arrays or any mix thereof which provides the desired level performance and cost.

As disclosed herein, implementations and features consistent with the present inventions may be implemented through computer-hardware, software and/or firmware. For example, the systems and methods disclosed herein may be embodied in various forms including, for example, a data processor, such as a computer that also includes a database, digital electronic circuitry, firmware, software, or in combinations of them. Further, while some of the disclosed implementations describe components such as software, systems and methods consistent with the invention herein may be implemented with any combination of hardware, software and/or firmware. Moreover, the above-noted features and other aspects and principles of the invention herein may be implemented in various environments. Such environments and related applications may be specially constructed for performing the various processes and operations according to the present invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention herein, or it may be more convenient to construct a specialized apparatus or system to perform the required methods and techniques.

Aspects of the method and system described herein, such as the logic, may be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioural, register transfer, logic component, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signalling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., Hypertext Transfer Protocol (HTTP), File Transfer Protocol (FTP), Simple Mail Transfer Protocol (SMTP), and so on).

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application.

Although certain presently preferred implementations of the present invention have been specifically described herein, it will be apparent to those skilled in the art to which the inventions pertain that variations and modifications of the various implementations shown and described herein may be made without departing from the scope of the inventions herein. Accordingly, it is intended that the inventions be limited only to the extent required by the appended claims and the applicable rules of law.

FIG. 3
condition coefficients 302-320
outermost contour 305
innermost contour 350
confidence L(x) 330
vector x 335 of the condition coefficients θ₁ and θ₂
nested sampling 340

FIG. 5
life estimation device 500
database 502
communication network 505.
processor 504
memory 506
communication unit 508
display unit 550
distribution module 510
sampling module 520
validation module 530
confidence function module 535
life estimation module 540.

FIG. 6
life estimation system 600
technical plant 610
server 604
network interface 605
technical systems 612-616

1. A method of estimation life of a technical system comprising of at least one material, the method comprising:
generating a coefficient distribution by determining probability distribution of condition coefficients associated with the material, wherein the condition coefficients include stress-strain coefficient, stress-life coefficient and structure coefficients;
sampling the coefficient distribution at a high confidence region and a low confidence region; and
estimating life of the material based on the sampled high confidence region and the sampled low confidence region.

2. The method as claimed in claim 1, wherein generating a coefficient distribution by determining probability distribution of condition coefficients associated with the material, comprises:
determining the probability distribution for each of the condition coefficients of the material based on relationship between maximum load on the material and number of load cycles to failure of the material;
determining mean of the probability distribution by optimizing the probability distribution based on dynamic tuning of the condition coefficients; and
generating the coefficient distribution based on the mean of the probability distribution.

3. The method as claimed in claim 2, further comprising:
determining distribution limits from the mean based on a perturbation analysis performed on the condition coefficients; and
generating the coefficient distribution based on the distribution limits.

4. The method as claimed in claim 1, wherein sampling the coefficient distribution at a high confidence region and a low confidence region, comprises:
weighing the samples based on a confidence function on each of the condition coefficients, wherein the high confidence region indicates on higher confidence function of the condition coefficients as with respect to the low likelihood region with lower confidence function; and
sampling the coefficient distribution at the high confidence region at a faster rate in relation to the low confidence region.

5. The method as claimed in claim 4, wherein weighing the samples based on a confidence function on each of the condition coefficients, comprises:
determining the confidence function on each of the condition coefficients.

6. The method as claimed in claim 5, wherein determining the confidence function on each of the condition coefficients, comprises:
validating each of the condition coefficients with known condition of the material, wherein the known condition comprises material domain knowledge, test data associated with the material, physics model and mathematical model; and
determining the confidence function based on the validation of each of the condition coefficients.

7. A life estimation device for a technical system comprising of at least one material, the device comprising:
a receiver to receive at least one test data;
at least one processor; and
a memory communicatively coupled to the at least one processor, the memory comprising:
a distribution module to generate a coefficient distribution from the test data by determining probability distribution of condition coefficients associated with the material, wherein the condition coefficients include stress-strain coefficient, stress-life coefficient and structure coefficients;
a sampling module to sample the coefficient distribution at a high confidence region and a low confidence region; and
a life estimation module to estimate life of the material based on the sampled high confidence region and the sampled low confidence region.

8. The device as claimed in claim 7, wherein the distribution module determines the probability distribution for each of the condition coefficients of the material based on relationship between maximum load on the material and number of load cycles to failure of the material.

9. The device as claimed in claim 7, wherein the distribution module determines mean of the probability distribution by optimizing the probability distribution based on dynamic tuning of the condition coefficients, and wherein the distribution module generates the coefficient distribution based on the mean of the probability distribution.

10. The device as claimed in claim 8, wherein the distribution module determines distribution limits from the mean based on a perturbation analysis performed on the condition coefficients, and wherein the coefficient distribution are generated based on the distribution limits.

11. The device as claimed in claim 7, further comprising:
a validation module to validate each of the condition coefficients with known condition of the material, wherein the known condition comprises material domain knowledge, test data associated with the material, physics model and mathematical model; and
a confidence function module to determine the confidence function based on the validation of each of the condition coefficients.

12. The device as claimed in claim 7, wherein the sampling module weighs the samples based on a confidence function on each of the condition coefficients, wherein the high confidence region indicates on higher confidence function of the condition coefficients as with respect to the low likelihood region with lower confidence function, and wherein the sampling module samples the coefficient distribution at the high confidence region at a faster rate in relation to the low confidence region,

13. A life estimation system for a technical plant, the technical plant comprising a plurality of technical system, each comprising at least one material, the life estimation system comprising:
a server operable on a cloud computing platform;
a network interface communicatively coupled to the server;
a life estimation device for each of the technical systems, the device comprising:
a receiver to receive at least one test data;
at least one processor; and
a memory communicatively coupled to the at least one processor, the memory comprising:
a distribution module to generate a coefficient distribution from the test data by determining probability distribution of condition coefficients associated with the material, wherein the condition coefficients include stress-strain coefficient, stress-life coefficient and structure coefficients;
a sampling module to sample the coefficient distribution at a high confidence region and a low confidence region; and
a life estimation module to estimate life of the material based on the sampled high confidence region and the sampled low confidence region.
